(19) United States
(12) Patent Application Publication
(10) Pub. No.: US 2019/0179368 A1
(43) Pub. Date: Jun. 13, 2019

(54) Smartphone Portable Computer System

(71) Applicant: Shengyi Li, Houston, TX (US)

(72) Inventor: Shengyi Li, Houston, TX (US)

(21) Appl. No.: 15/983,380

(22) Filed: May 18, 2018

Related U.S. Application Data
(60) Provisional application No. 62/595,664, filed on Dec. 7, 2017.

(51) Int. Cl. G06F 1/16; H04M 1/02; G06F 3/02

(52) U.S. Cl. CPC G06F 1/1632; H04M 1/0202; G06F 1/1656; G06F 3/03543; G06F 1/1635; G06F 3/0227; H04M 1/0279; G06F 1/1637

(57) ABSTRACT

A new type of portable computer is disclosed. The disclosed portable computer includes a display device, a shell enclosure which includes a keyboard and a video keyboard interface, and a smartphone which also includes a video keyboard interface. The new portable computer works like a regular laptop computer with additional smart phone functionalities. The smartphone and the shell enclosure may be connected by inserting the smartphone into the shell enclosure from inside or outside, via a connecting cable, or wirelessly.

### CROSS-REFERENCE TO RELATED APPLICATIONS

This is a non-provisional of U.S. Provisional Application Ser. No. 62/595,664, filed 7 Dec. 2017, and entitled “Method for Combination of Mobile Phone with Laptop into Smart Phone Workstation,” which is incorporated herein by reference in its entirety and to which priority is claimed.

### FIELD OF THE INVENTION

The subject matter of the present disclosure relates generally to a new type of portable computer, specifically, a portable computer equipped with a smartphone.

### BACKGROUND OF THE INVENTION

The launch of the iPhone in 2007 transformed the humble mobile phone from a one-trick tool for communication into a catch-all platform. The functionality of the smartphone is constantly evolving. Nowadays, a smartphone may be used as a camera, a video recorder, a notebook, a video game player, as well as a personal computer. More and more people use their smartphones to handle tasks used to be handled on a personal computer. However, because of the smaller size of the smartphone comparing to a personal computer, working on a smartphone is not as comfortable as working on a computer. Moreover, because of limited storage space on smartphones, often times people have to connect the smartphone to a computer to transfer data from the smartphone to the computer.

It is, therefore, desirable to provide a new type of device to combine functionality of the smartphone and the computer together.

### OBJECTIVES AND SUMMARY OF THE INVENTION

The main objective of the present disclosure is to combine a smart phone with shell workstation and form a new, unprecedented type of laptop—smartphone portable computer. The smartphone portable computer works like a regular laptop with additional smartphone functionality.

In accordance with some embodiments, a smartphone portable computer system includes a display device, a shell enclosure and a smartphone. The shell enclosure has a video keyboard interface and the smartphone also has a video keyboard interface.

According to one embodiment, the smartphone and the shell enclosure are connected via plugging the male video keyboard interface into the female video keyboard interface.

According to another embodiment, the smartphone and the shell enclosure are connected via a connecting cable.

According to yet another embodiment, the smartphone and shell enclosure are connected wirelessly.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates some components in a shell enclosure of a smartphone portable computer system according to some embodiments;

FIG. 2 illustrates an exemplary video keyboard interface of a smartphone portable computer system according to some embodiments;

FIG. 3 illustrates an exemplary smartphone of a smartphone portable computer system according to some embodiments;

FIG. 4 illustrates an exemplary smartphone portable computer system with the smartphone inserted into the shell enclosure and the male VKI interface plugged into the female VKI interface according to some embodiments;

FIG. 5 illustrates another exemplary smartphone portable computer system with the smartphone connected to the shell enclosure through plugging the male VKI interface into the female VKI interface according to some embodiments;

FIG. 6 illustrates another exemplary smartphone portable computer system with the smartphone connected to the shell enclosure via a connection cable according to some embodiments;

FIG. 7 illustrates yet another exemplary smartphone portable computer system with the smartphone wireless connected to the shell enclosure according to some embodiments.

### DETAILED DESCRIPTION OF THE EMBODIMENTS

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular exemplary embodiments only and is not intended to be limiting. As used herein, the singular forms “a,” “an,” and “the” may be intended to include the plural forms as well, unless the context expressly indicates otherwise. It will be further understood that the terms “comprise,” “comprises,” and/or “comprising,” “include,” “includes,” and/or “including,” when used in the present disclosure, specify the presence of stated features, integers, steps, operation, elements, and/or components, but do not preclude the presence or addition of one or more other features, integers, steps, operation, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for illustration and description only, and are not intended to limit the scope of the present disclosure. It is understood that the drawings are not to scale.

It will be understood that the term “system,” “engine,” “unit,” and/or “module” used herein are one method to distinguish different components, elements, parts, sections, or assemblies of different levels in ascending order. However, the terms may be displaced by other expressions if they achieve the same purpose.

It will be understood that when a unit, engine, or module is referred to as being “on,” “connected to,” or “coupled to,” another unit, engine, or module, it may be directly on, connected or coupled to, or communicate with the other unit, engine, or module, or an intervening unit, engine, or module may be present, unless the context clearly indicates otherwise. As used herein, the term “and/or” includes any and all combinations of one or more of the associated listed items.

The flowcharts used in the present disclosure illustrate operation that systems implement according to some embodiments of the present disclosure. It is to be expressly understood, the operation of the flowcharts may be implemented not in order. Conversely, the operation may be implemented in inverted order, or simultaneously. Moreover, one or more other operations may be added to the flowcharts. One or more operations may be omitted from the flowcharts.

Comparing with a typical laptop computer, the smartphone portable computer system disclosed herein does not have a typical laptop mainboard, CPU and RAM card. The disclosed smartphone portable computer system includes a workstation which comprises a display device and a shell enclosure, and a smartphone. The display device may be a separate device, or a part of the shell enclosure.

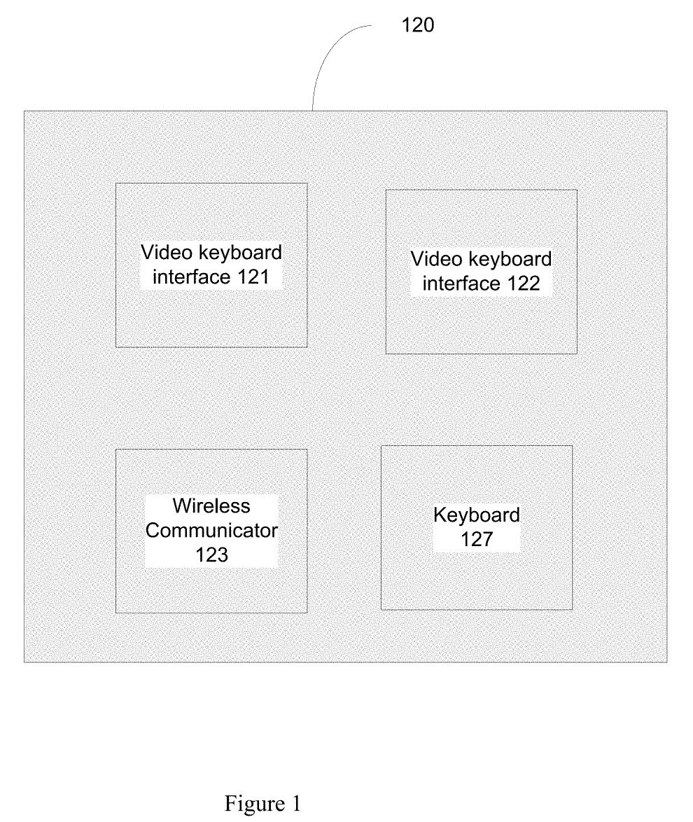

FIG. 1 illustrates an exemplary shell enclosure 120, which includes a keyboard 127, a video keyboard interface (VKI) 121, a VKI 122, and/or a wireless communicator 123. The shell enclosure 120 may also include a mouse (not shown). The VKI 121 is placed inside the shell enclosure 120 for connecting with a smartphone when the smartphone is inserted into the shell enclosure. The VKI 122 is placed on the side of the shell enclosure 120 for connection with a smartphone via a connection cable. In accordance with some embodiments, the shell enclosure 120 may also include a hard disk for file storage, and/or a battery (not shown).

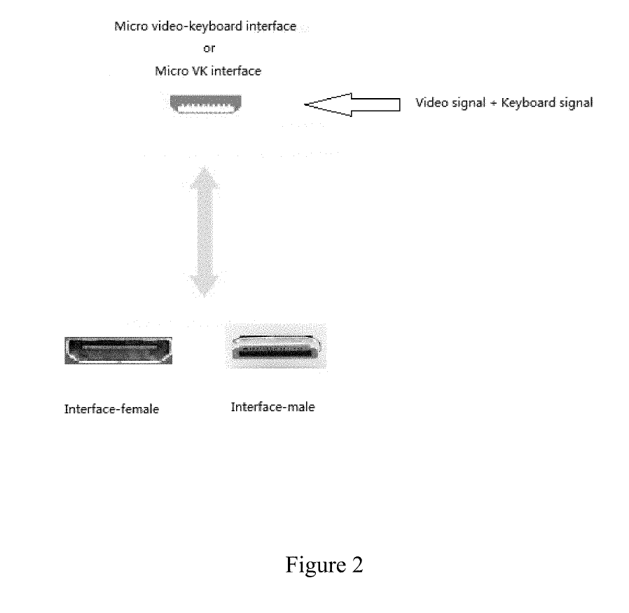

In accordance with some embodiments of the present disclosure, VKI interface combines the video interface (including VGA, DVI, DisplayPort or HDMI) with keyboard interface (including PS/2 or USB). FIG. 2 illustrates some exemplary embodiments of the VKI interface.

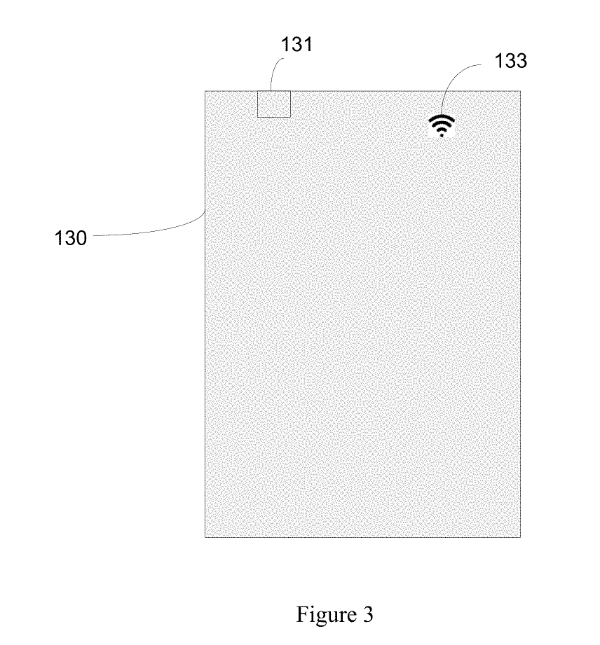

FIG. 3 illustrates an exemplary smartphone 130 in accordance with some embodiments of the present disclosure. The smartphone 130 has a VKI interface 131 and/or a wireless communicator 133. In accordance with some embodiments, the smartphone has two interfaces instead of a VKI interface: a video interface such as micro VGA, micro DVI, micro DisplayPort, micro HDMI or mini HDMI and a keyboard interface such as micro PS/2 or micro USB.

There are several ways to connect the smartphone 130 to the shell enclosure 120.

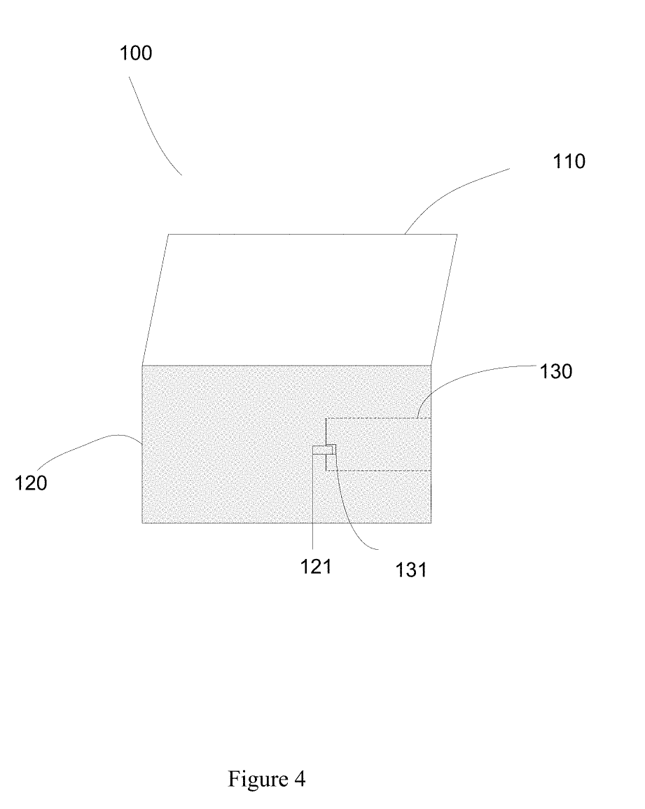

FIG. 4 illustrates one exemplary connection of the smartphone 130 and the shell enclosure 120. As shown in FIG. 4, the smartphone portable computer system 100 has a display 110, a shell enclosure 120 and a smartphone 130. The smartphone 130 is inserted into the shell enclosure 120. The smartphone 130 and the shell enclosure 120 are connected via VKI 121 on the shell enclosure 120 and a VKI 131 on the smartphone 130. One of the VKI 121 and VKI 131 is a male interface, and the other is a female interface. When inserting the smartphone 130 into the shell enclosure 120, the male VKI interface is plugged into the female VKI interface. Once the connection is established, data and video information from the smartphone 130 may be transmitted to the shell enclosure 120 and displayed on the display 110. Data input from the keyboard 127 may be transmitted to the smartphone 130. The smartphone 130 may be easily pulled out of the shell enclosure 130. In one embodiment, the VKI 121 is a male interface, and the VKI 131 is a female interface. In one embodiment, the smartphone is 130 is partially inserted into the shell enclosure 120.

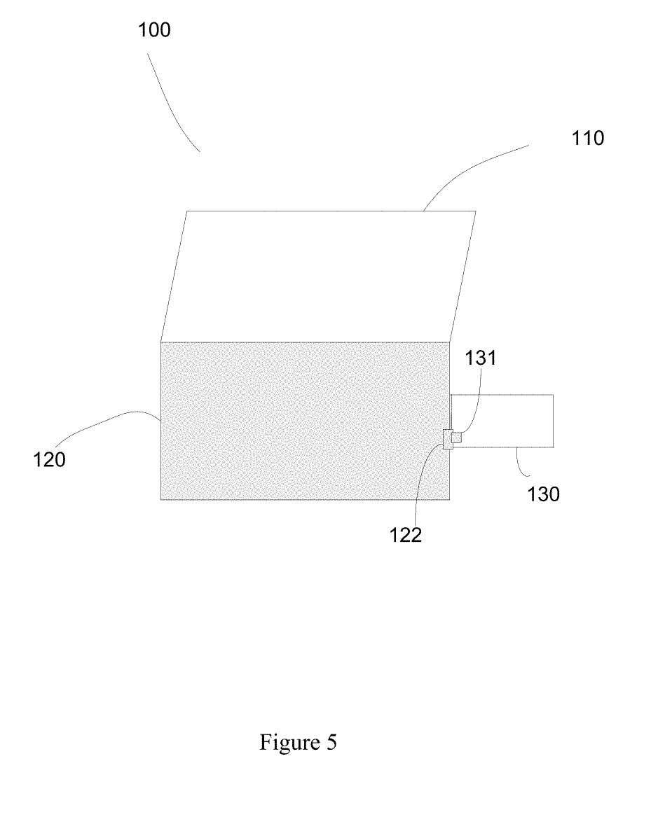

FIG. 5 illustrates another exemplary connection of the smartphone 130 and the shell enclosure 120 by plugging the male interface into the female interface. As shown in FIG. 5, the VKI 122 is on a side of the shell enclosure 120. One of the VKI 122 and VKI 131 is a male interface, and the other is a female interface. When connecting the smartphone 130 with the shell enclosure 120, the male VKI interface is plugged into the female VKI interface. In one embodiment, the VKI 122 is a male interface, and the VKI 131 is a female interface.

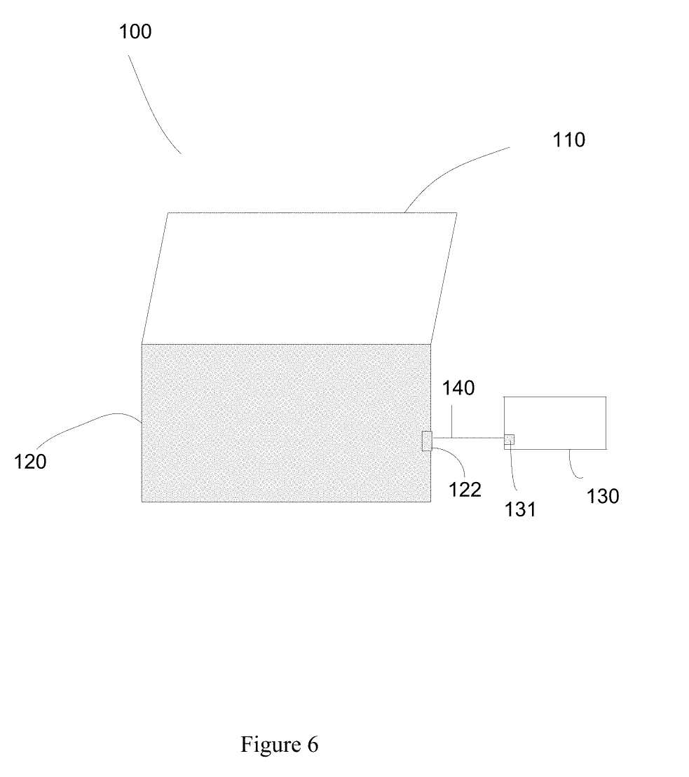

FIG. 6 illustrates another exemplary connection of the smartphone 130 and the shell enclosure 120. As shown in FIG. 6, the smartphone 130 is connected to the shell enclosure 120 via a connection cable 140. The connection cable 140 connects a VKI 122 on the shell enclosure 120 and a VKI 131 on the smartphone 130. Once the connection is established, data and video information from the smartphone 130 may be transmitted to the shell enclosure 120 and displayed on the display 110. Data input from the keyboard 127 may be transmitted to the smartphone 130. In one embodiment, both VKI 122 and VKI 131 are female interfaces. In another embodiment, one is a male interface, and the other is a female interface. In some embodiments, the shell enclosure 120 and smartphone 130 have two interfaces instead of one VKI interface: a video interface such as micro VGA, micro DVI, micro DisplayPort, micro HDMI or mini HDMI and a keyboard interface such as micro PS/2 or micro USB.

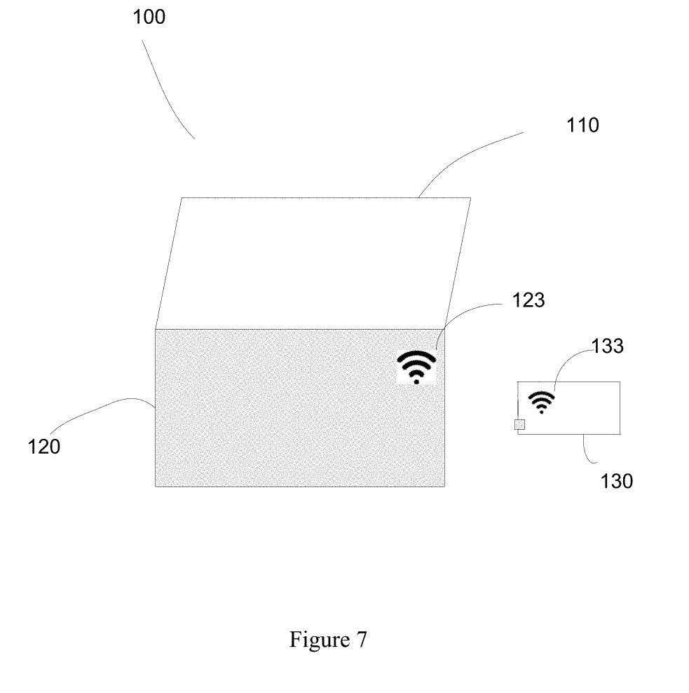

FIG. 7 illustrates yet another exemplary connection of the smartphone 130 and the shell enclosure 120. As shown in FIG. 7, the smartphone 130 wirelessly communicates with the shell enclosure 120 via a wireless communicator 123 on the shell enclosure 120 and a wireless communicator 133 on the smartphone 130. Once the wireless connection is established, data and video information from the smartphone 130 may be transmitted to the shell enclosure 120 and displayed on the display 110. Data input from the keyboard 127 may be transmitted to the smartphone 130. The wireless communicators 123 and 133 may include a video wireless module such as wireless HDMI, WHDI or WiGig and a keyboard wireless module such as Bluetooth.

With the configuration disclosed herein, the smartphone portable computer works like a regular laptop computer, and has more functions than a regular laptop—with the function of smart phone. When the smart phone disconnects with the workstation, the smart phone is still a mobile phone, but the workstation does not work. When the smart phone connects with the workstation, the workstation will become a working smart phone workstation. It will work similarly as a regular laptop, and the user can receive call or call somebody at the same time. Another advantage of the disclosed smartphone portable computer system is that there is no need to transfer data between a mobile phone and a laptop.

In one embodiment, the smartphone 130 has installed one operating system for a mobile phone, phone OS. Phone OS operates the smartphone and smartphone portable computer.

In another embodiment, the smartphone 130 has two operating systems installed: phone OS and PC OS. When the smartphone disconnects with the workstation, the smartphone will operate on phone OS. When the smartphone connects with the workstation, the use may select either phone OS or PC OS to operate.

Although some preferred configurations of a smartphone portable computer in accordance with the present invention have been described herein with respect to a limited number of embodiments, those skilled in the art will recognize that various substitutions and modifications may be made to the specific features described above without departing from the scope and spirit of the invention as recited in the appended claims.

1. A smartphone portable computer system, comprising:
a shell enclosure,
a display device connected to the shell enclosure, and
a smartphone coupled to the shell enclosure via a video-keyboard connection,
wherein the shell enclosure comprises a keyboard and a first video keyboard interface, the smartphone comprises a second video keyboard interface, and the video-keyboard connection transmits both keyboard signal and video signal.

2. The smartphone portable computer system according to claim 1, wherein the shell enclosure further comprises a mouse.

3. The smartphone portable computer system according to claim 1, wherein the shell enclosure further comprises a storage drive.

4. The smartphone portable computer system according to claim 1, wherein the shell enclosure further comprises a battery.

5. The smartphone portable computer system according to claim 1, wherein the first video keyboard interface is located inside the shell enclosure, the second video keyboard interface is located at a side of the smartphone, the video-keyboard connection between the smartphone and the shell enclosure is through inserting the smartphone into the shell enclosure with the first video keyboard interface connected with the second video keyboard interface.

6. The smartphone portable computer system according to claim 1, wherein the first video keyboard interface is located at a side of the shell enclosure, the second video keyboard interface is located at a side of the smartphone, the video-keyboard connection between the smartphone and the shell enclosure is through plugging the first video keyboard interface into the second video keyboard interface.

7. The smartphone portable computer system according to claim 1, wherein the first video keyboard interface is located at a side of the shell enclosure, the second video keyboard interface is located at a side of the smartphone, the video-keyboard connection between the smartphone and the shell enclosure is through a connecting cable connecting the first video keyboard interface and the second video keyboard interface.

8. The smartphone portable computer system according to claim 1, wherein the shell enclosure further comprises a first wireless communicator and the smartphone further comprises a second wireless communicator.

9. The smartphone portable computer system according to claim 8, wherein the video-keyboard connection between the smartphone and the shell enclosure is a wireless connection.

10. The smartphone portable computer system according to claim 1, wherein the smartphone further comprises two or more operating systems installed.
